(19) United States
(12) Patent Application Publication
(10) Pub. No.: US 2024/0209526 A1
(43) Pub. Date: Jun. 27, 2024

(54) MAGNETITE ELECTROCATALYST

(71) Applicant: KING FAHD UNIVERSITY OF PETROLEUM AND MINERALS, Dhahran (SA)

(72) Inventor: Muhammad Ali EHSAN, Dhahran (SA)

(73) Assignee: KING FAHD UNIVERSITY OF PETROLEUM AND MINERALS, Dhahran (SA)

(21) Appl. No.: 18/085,629

(22) Filed: Dec. 21, 2022

(51) Int. Cl. C25B 11/077; C25B 1/04; C25B 11/031; C25B 11/061

(52) U.S. Cl. CPC C25B 11/077; C25B 1/04; C25B 11/031; C25B 11/061

(57) ABSTRACT

An electrocatalyst including an iron foam substrate and magnetite (Fe₃O₄). At least one layer of the Fe₃O₄ is deposited onto the iron foam substrate. At least one layer of the Fe₃O₄ on the iron foam substrate is continuous. At least one layer of the Fe₃O₄ on the iron foam substrate has a thickness of 0.01 micrometer (μm) to 50 μm. The Fe₃O₄ is in a form of particles having a spherical shape with an average diameter of 0.01 to 2 μm.

### BACKGROUND

### Technical Field

The present disclosure is directed to an electrocatalyst, and particularly to an electrocatalyst including magnetite particles on porous metallic substrates for electrolytic water splitting.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Photo-electrochemical and electrochemical water splitting is a way to convert renewable resources to fuels such as hydrogen. The electrocatalytic water splitting process is inherently sensitive to the capacity of the electrocatalyst, and hence the energy conversion efficiency of the process is mainly dependent on the type of catalyst used. Generally, electrochemical water splitting includes two steps: oxygen evolution reaction (OER) at the anode and hydrogen evolution reaction (HER) at the cathode. Hydrogen-based fuel production via water splitting is mainly hindered at the industrial scale due to the sluggish four-electron transfer process involved in the OER. Therefore, designing new OER catalytic materials that are efficient, scalable, stable, and reduce the overpotential is necessary to improve the potential of using water splitting for fuel generation.

Conventionally used Ru and Ir-based electrocatalysts have good OER performance under acidic and alkaline conditions, however, such catalysts suffer from high cost and scarcity, ultimately limiting their potential. Development of low-cost, earth-abundant transition metal-based effective electrocatalytic systems has been explored. However, further research is needed to lower the cost of the catalytic system and to improve the catalytic performance by simplifying the preparation method.

Fe is an environmentally friendly and abundant transition metal in the earth's crust. Simple Fe-based catalysts are not typically used for catalysis, however, Fe is an essential co-catalyst for Co and Ni and Fe impurities in catalysts has been shown to enhance the overall activity of catalytic systems. For Fe-based catalysts (oxides, hydroxides, and oxy-hydroxides), a limit of their activity is due to low conductivity and limited reaction sites. Therefore, improvement of electrode design with nanoscale features, a larger number of electroactive sites, and a highly pure catalytic phase can improve Fe-based catalysts for OER.

In order to overcome the limitations of the prior art, it is one object of the present disclosure to provide an electrocatalyst including iron. It is another object of the present disclosure to provide an electrocatalyst including iron with a high activity for OER.

### SUMMARY

In an exemplary embodiment, an electrocatalyst is described. The electrocatalyst includes an iron foam substrate and magnetite (Fe₃O₄), where at least one layer of the Fe₃O₄ is deposited onto the iron foam substrate, and where the at least one layer of the Fe₃O₄ on the iron foam substrate is continuous. The at least one layer of the Fe₃O₄ on the iron foam substrate has a thickness of 0.01 micrometer (μm) to 50 μm. The Fe₃O₄ is in a form of particles having a spherical shape with an average diameter of 0.01 to 2 μm.

In some embodiments, the Fe₃O₄ is uniformly distributed on the iron foam substrate.

In some embodiments, particles of the Fe₃O₄ are not aggregated.

In some embodiments, particles of the Fe₃O₄ form a monolayer on the iron foam substrate.

In some embodiments, at least 90% of an outer surface area of the iron foam substrate is covered with particles of the Fe₃O₄.

In some embodiments, the average diameter of the particles of Fe₃O₄ is 0.1 to 1 μm.

In some embodiments, the Fe₃O₄ has a cubic phase.

In some embodiments, the electrocatalyst has Fe²⁺ and Fe₃₊ species.

In some embodiments, a distribution of the average diameter of the particles of Fe₃O₄ does not vary by more than 100 nanometers (nm).

In some embodiments, the iron foam substrate is porous and has an average pore size of 50 to 500 μm.

In some embodiments, the pores have a spherical shape.

In some embodiments, the electrocatalyst has 60-80 wt. % iron and 20-40 wt. % oxygen, based on a total weight of the electrocatalyst.

In another exemplary embodiment, an oxygen evolution catalytic system is provided. The system includes the electrocatalyst, including an iron foam substrate, and magnetite (Fe₃O₄), where at least one layer of the Fe₃O₄ is deposited onto the iron foam substrate, and where the at least one layer of the Fe₃O₄ on the iron foam substrate is continuous. The at least one layer of the Fe₃O₄ on the iron foam substrate has a thickness of 0.01 μm to 50 μm, and where the Fe₃O₄ is in a form of particles having a spherical shape with an average diameter of 0.01 to 2 μm. The system further includes a counter electrode and an electrolyte. The electrocatalyst and the counter electrode are at least partially submerged in an aqueous solution of the electrolyte and are not in physical contact with each other.

In some embodiments, the electrolyte is a base selected from the group consisting of an alkaline earth metal hydroxide and an alkali metal hydroxide.

In some embodiments, the electrolyte is 0.1-3 molar (M) potassium hydroxide in an aqueous solution.

In some embodiments, the counter electrode is made from a material selected from the group consisting of platinum, gold, and carbon.

In some embodiments, the system has a specific activity of milliampere per square centimeter (2-4 mA/cm²).

In some embodiments, the system has an overpotential of 150 to 200 millivolts (mV), at 10 mA/cm².

In some embodiments, the system has a turnover frequency of 2-6 seconds inverse (s⁻¹) at an overpotential of 0.32 V.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an X-Ray diffraction (XRD) pattern of magnetite (Fe₃O₄) thin film deposited at 480° C. on a plain glass substrate for 80 minutes using an aerosol-assisted chemical vapor (AACVD) method, according to certain embodiments of the present disclosure;

FIG. 2A is a high-resolution image of Fe₃O₄ electrocatalytic film grown over iron foam substrate (FeF) (Fe₃O₄-ECs/FeF) at 50 μm, according to certain embodiments of the present disclosure;

FIG. 2B is an overview image of a Fe₃O₄-ECs/FeF at 5 μm, according to certain embodiments of the present disclosure;

FIG. 2C is a high-resolution image of the Fe₃O₄ electrocatalytic film grown over stainless-steel mesh substrate (SS) (Fe₃O₄-ECs/SS) at 50 μm, according to certain embodiments of the present disclosure;

FIG. 2D is an overview image of the Fe₃O₄-ECs/SS at 5 μm, according to certain embodiments of the present disclosure;

FIG. 2E is a high-resolution image of the Fe₃O₄ electrocatalytic film grown over nickel foam substrate (NiF) (Fe₃O₄-ECs/NiF) at 50 μm, according to certain embodiments of the present disclosure;

FIG. 2F is an overview image of the Fe₃O₄-ECs/NiF at 5 μm, according to certain embodiments of the present disclosure;

FIG. 3A-B is an Energy dispersive X-Ray (EDX) spectrum for the corresponding image of the Fe₃O₄ electrocatalytic film deposited at 480° C. on the FeF substrate for 80 minutes, according to certain embodiments of the present disclosure;

FIG. 4A-B is an EDX spectrum for the corresponding image of the Fe₃O₄ electrocatalytic film deposited at 480° C. on the SS substrate for 80 minutes, according to certain embodiments of the present disclosure;

FIG. 5A-B is an EDX spectrum for the corresponding image of the Fe₃O₄ electrocatalytic film deposited at 480° C. on the NiF substrate for 80 minutes, according to certain embodiments of the present disclosure;

FIGS. 6A-6D show EDX elemental mapping analysis for the Fe₃O₄-ECs/FeF, according to certain embodiments of the present disclosure;

FIGS. 6E-6H show EDX elemental mapping analysis for the Fe₃O₄-ECs/SS, according to certain embodiments of the present disclosure;

FIGS. 6I-6L show EDX elemental mapping analysis for the Fe₃O₄-ECs/NiF, according to certain embodiments of the present disclosure;

FIG. 7A is an X-ray photoelectron spectroscopy (XPS) spectrum of Fe 2p element involved in the Fe₃O₄ thin film, according to certain embodiments of the present disclosure;

FIG. 7B is an XPS spectrum of O 1s element involved in the Fe₃O₄ thin film, according to certain embodiments of the present disclosure;

FIG. 8 is a graph depicting 1^{st}, and 40th concurrent cyclic voltammetry (CVs) recorded at a scan rate of 50 millivolts per second (mV s⁻¹) for the Fe₃O₄-ECs/FeF in 1.0 M aqueous (aq) KOH electrolyte solution, according to certain embodiments of the present disclosure;

FIG. 9 is a graph depicting 1^{st} and 40^{th} concurrent CVs recorded at a scan rate of 50 mV s⁻¹ for the Fe₃O₄-ECs/NiF in 1.0 M aq. KOH electrolyte solution, according to certain embodiments of the present disclosure;

FIG. 10 is a graph depicting the 1st and 40th concurrent CVs recorded at a scan rate of 50 mV s⁻¹ for the Fe₃O₄-ECs/SS in 1.0 M aq. KOH electrolyte solution, according to certain embodiments of the present disclosure;

FIG. 11A is a graph depicting forward potential sweeps for oxygen evolution reaction (OER) recorded at a scan rate of 5 mV s⁻¹ for bare FeF, SS, NiF and Fe₃O₄-ECs/FeF, Fe₃O₄-ECs/SS, Fe₃O₄-ECs/NiF in 1.0 M aq. KOH electrolyte solution, according to certain embodiments of the present disclosure;

FIG. 11B is a graph depicting an enlarged view of linear sweep voltammetry (LSV) curves for the Fe₃O₄-ECs/FeF, Fe₃O₄-ECs/SS, Fe₃O₄-ECs/NiF in 1.0 M aq. KOH electrolyte solution, according to certain embodiments of the present disclosure;

FIG. 12 is a graph depicting forward potential sweeps for OER recorded at a scan rate of 5 mV s⁻¹ for the Fe₃O₄-ECs/FeF, commercially available NiO-ECs, CoO-ECs, and IrO₂-ECs in 1.0 M aq. KOH electrolyte solution, according to certain embodiments of the present disclosure;

FIG. 13 is a bar graph depicting a comparison of overpotential at an onset of OER and various current density values for the Fe₃O₄-ECs/FeF, Fe₃O₄-ECs/SS, Fe₃O₄-ECs/NiF, according to certain embodiments of the present disclosure;

FIG. 14A is a graph depicting Nyquist plots for the Fe₃O₄-ECs/FeF, Fe₃O₄-ECs/SS, and Fe₃O₄-ECs/NiF recorded at an overpotential of 320 millivolts (mV) in a frequency range from 0.1 hertz (Hz) to 100000 Hz in 1.0 M KOH solution, according to certain embodiments of the present disclosure;

FIG. 14B is a graph depicting Tafel plots and corresponding Tafel slope values for the Fe₃O₄-ECs/FeF, Fe₃O₄-ECs/SS, and Fe₃O₄-ECs/NiF directly obtained from a linear Tafel region of polarization curves at or near an onset potential where the linear Tafel region begins, according to certain embodiments of the present disclosure;

FIG. 14C is a bar graph depicting charge-transfer resistance values at electrode-electrolyte interphase and exchange current density values directly obtained from charge-transfer resistance values for the Fe₃O₄-ECs/FeF, Fe₃O₄-ECs/SS, and Fe₃O₄-ECs/NIF, according to certain embodiments of the present disclosure;

FIG. 14D is a graph depicting turnover frequency (TOF) directly calculated from the polarization curve at various applied potentials for the Fe₃O₄-ECs/FeF, Fe₃O₄-ECs/SS, and Fe₃O₄-ECs/NiF in 1.0 M aq. KOH electrolyte solution, according to certain embodiments of the present disclosure;

FIG. 15A is a graph depicting CV of the Fe₃O₄-ECs/FeF measured at various scan rates, such as from 10 mV s⁻¹ to 60 mV s⁻¹ in non-faradaic regions of polarization curve (where all obtained current is supposed to be due to capacitive charging only), according to certain embodiments of the present disclosure;

FIG. 15B is a graph depicting oxidative and reductive charging current of the Fe₃O₄-ECs/FeF measured at a fixed potential of 1.15 V (vs. RHE) ultimately plotted as a function of scan rate, according to certain embodiments of the present disclosure;

FIG. 15C is a graph depicting CVs of the Fe₃O₄-ECs/SS measured at various scan rates, such as from 10 mV s⁻¹ to 60 mV s⁻¹ in non-faradaic regions of a polarization curve (where all obtained current is supposed to be due to capacitive charging), according to certain embodiments of the present disclosure;

FIG. 15D is a graph depicting oxidative and reductive charging current of the Fe₃O₄-ECs/SS measured at a fixed potential of 1.15 V (vs. RHE) ultimately plotted as a function of scan rate, according to certain embodiments of the present disclosure;

FIG. 15E is a graph depicting CVs of the Fe₃O₄-ECs/NiF measured at various scan rates, from 10 mV s⁻¹ to 60 mV s⁻¹ in the non-faradaic regions of the polarization curve (where all obtained current is supposed to be due to capacitive charging only), according to certain embodiments of the present disclosure;

FIG. 15F is a graph depicting oxidative and reductive charging current of the Fe₃O₄-ECs/NiF measured at a fixed potential of 1.18 V (vs. RHE) ultimately plotted as a function of scan rate, according to certain embodiments of the present disclosure;

FIG. 16A is a bar graph depicting mass activities for the Fe₃O₄-ECs/FeF, Fe₃O₄-ECs/SS, and Fe₃O₄-ECs/NiF, according to certain embodiments of the present disclosure;

FIG. 16B is a bar graph depicting electrochemically active surface area (ECSA) and specific activity values for the Fe₃O₄-ECs/FeF, Fe₃O₄-ECs/SS, and Fe₃O₄-ECs/NiF, according to certain embodiments of the present disclosure;

FIG. 17A is a graph depicting controlled current electrolysis (CCE) curves for the bare FeF, SS, NiF, and Fe₃O₄-ECs/FeF, Fe₃O₄-ECs/SS, Fe₃O₄-ECs/NiF at a fixed current density of 10 and 20 milliamperes per square centimeter (mA/cm²), according to certain embodiments of the present disclosure;

FIG. 17B is a plot depicting catalytic stability, according to certain embodiments of the present disclosure;

FIG. 18A is a graph depicting forward potential sweeps for OER recorded at a scan rate of 5 mV s⁻¹ Fe₃O₄-ECs/FeF before and after a long-term stability test in 1.0 M aq. KOH electrolyte solution, according to certain embodiments of the present disclosure;

FIG. 18B is a graph depicting forward potential sweeps for OER recorded at a scan rate of 5 mV s⁻¹ Fe₃O₄-ECs/SS before and after a long-term stability test in 1.0 M aq. KOH electrolyte solution, according to certain embodiments of the present disclosure; and

FIG. 18C is a graph depicting forward potential sweeps for OER recorded at a scan rate of 5 mV s⁻¹ Fe₃O₄-ECs/NiF before and after the long-term stability test in 1.0 M aq. KOH electrolyte solution, according to certain embodiments of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

All ranges disclosed herein are inclusive of the endpoints, and the endpoints are independently combinable with each other, and inclusive of all intermediate values of the ranges. Thus, ranges articulated within this disclosure, e.g. numerics/values, shall include disclosure for possession purposes and claim purposes of the individual points within the range, sub-ranges, and combinations thereof.

Aspects of the present disclosure are directed to electrocatalysts for use in electrocatalytic water splitting. The electrocatalysts include magnetite (Fe₃O₄) thin films on Fe foam (FeF) produced with aerosol assisted chemical vapor deposition (AACVD). The catalysts are characterized with various analytical techniques for their morphological and electrochemical properties.

The electrocatalyst includes a substrate onto which metal-oxide particles are dispersed or deposited. The substrate may be any porous metallic substrate such as a stainless-steel mesh (SS), a Ni foam (NiF), or an iron foam (FeF) substrate. In a preferred embodiment, the substrate is FeF. In an embodiment, the iron foam substrate may optionally include metals in addition to iron, such as nickel, aluminum, or alloys thereof. The FeF substrate is a low-density and porous material. In an embodiment, the average pore size of the FeF substrate is about 50 to 500 micrometers (μm), preferably 100-450 μm, 150-400 μm, 200-350 μm, or 250-300 μm. The pores have shapes, such as cubical, conical, cuboidal, pyramidical, or cylindrical shape. In a preferred embodiment, the pores have a spherical shape. In a more preferred embodiment, the pores are regularly spaced on the substrate. In an embodiment, the pores are regularly spaced every 10-100 μm, preferably 30-80 μm, or approximately every 50 μm on the substrate. In another embodiment, the pores are randomly spaced on the substrate. In an embodiment, 75-95% of the surface area of the substrate is a void space, preferably 80-90% or approximately 85%.

In an embodiment, the metal oxide particles include as the metal Au, Ag, Pt, Pd, Ni, Co, Rh, Ru, Mn, Cr, Mo, Re, W, Ta, Nb, V, Fe, Hf, Zr, Ti or Al. In a preferred embodiment, the metal oxide particles are iron oxide. In a more preferred embodiment, the iron oxide is magnetite (Fe₃O₄). In another embodiment, the iron oxide is wüstite (FeO), magnetite, and/or hematite (Fe₂O₃). In a preferred embodiment, the iron oxide is pure magnetite. In another embodiment, the iron oxide is a combination of iron oxides. In some embodiments, metal oxide may include both Fe²⁺ and Fe₃₊ species or just one.

In some embodiments, the layer on the iron foam substrate consists of Fe₃O₄. In some embodiments, the layer on the iron foam substrate consists of particles of Fe₃O₄. In some embodiments, the layer on the iron foam substrate consists essentially of particles of Fe₃O₄. There are no other components or oxides on the surface of the iron foam substrate other than the particles of Fe₃O₄.

In an embodiment, the Fe₃O₄ has a cubic phase. In another embodiment, the Fe₃O₄ may have a phase selected from triclinic, monoclinic, orthorhombic, tetragonal, trigonal, hexagonal, and cubic. In an embodiment, the Fe₃O₄ particles have a rod, triangular, spherical, cubic, flake, or platelet shape. In a preferred embodiment, the Fe₃O₄ particles are substantially spherical. Spherical particles can form thin layers with a high packing density compared to other shapes. In an embodiment, the Fe₃O₄ is in a form of spherical particles having an average diameter of 0.01 to 2 μm, preferably 0.1 to 1.5 μm, or 0.5 to 1 μm. The distribution of the average diameter of the particles of Fe₃O₄ does not vary by more than 100 nanometers (nm), preferably 90 nm, 80 nm, 70 nm, 60 nm, 50 nm, 40 nm, 30 nm, 20 nm, or 10 nm. In other words, if the Fe₃O₄ particles have an average size of 1 μm, there are no particles greater in size than 1.1 μm or smaller in size than 0.9 μm.

In an embodiment, the substrate is deposited partially or wholly with a layer of the Fe₃O₄ particles. In an embodiment, 1-50 layers are deposited on the substrate, preferably 5-40, 10-30 or approximately 20 layers. The thickness of the Fe₃O₄ layer on the FeF substrate is in a range of 0.01 μm to 50 μm, more preferably 10 to 45 μm and yet more preferably 20-35 μm. In an embodiment, the Fe₃O₄ particles cover more than 40%, preferably 70%, and more preferably, greater than 90% of the outer surface area of the substrate. In an embodiment, 100% of the substrate is covered with Fe₃O₄ particles. In some embodiments, the electrocatalyst has 50-80 wt. % iron, preferably 60-70 wt. % or approximately 65 wt. %, and 20-40 wt. % oxygen, preferably 25-35 wt. %, or approximately 30 wt. %, based on the total weight of the electrocatalyst.

In an embodiment, particles of the Fe₃O₄ form a continuous, uniform, monolayer on the iron foam substrate. In other words, the Fe₃O₄ particles are in contact with one another and densely packed along the surface of the substrate. In some embodiments, the surfaces of the Fe₃O₄ particles have —OH or adsorbed water.

Agglomeration of the Fe₃O₄ particles can affect the properties of the electrocatalyst. Agglomeration or aggregation of the Fe₃O₄ particles may result in difficulties in dispersing the particles onto the substrate. It is therefore preferred that there is minimal or no aggregation of the particles. The particles of the Fe₃O₄ prepared by the method of the present disclosure are not aggregated. While not wishing to be bound to a single theory, it is thought that aggregates are not formed due to the Fe—Fe interaction between iron foam and the iron from deposited magnetite. The Fe atoms present in iron foam act as a seeds for the uniform and dense spherical growth of magnetite.

In some embodiments, deposition/dispersion of the magnetite thin films over the FeF substrate is performed under aerosol-assisted chemical vapor (AACVD) conditions. AACVD deposition method is more controllable where physicochemical properties of film material such as morphology, and thickness can be tuned easily by simply varying deposition time, temperature, and precursor solvent, reproducible and versatile than other approaches. Depositing by AACVD prevents the formation of aggreagtes and leaching of the metal during catalysis. In some embodiments, the carrier gas during AACVD is nitrogen or argon. In some embodiments, the temperature during AACVD is from 400-600° C., preferably 450-550° C. or approximately 500° C. In some embodiments, the deposition process is carried out for at least 30 minutes, preferably 30-150 mins, 50-100 minutes or 70-80 minutes.

According to an aspect of the present disclosure, an oxygen evolution catalytic system (also referred to as the system) is also provided. The system includes the electrocatalyst, a counter electrode, and an electrolyte. The electrocatalyst and the counter electrode are at least partially submerged in an aqueous solution of the electrolyte and are not in physical contact with each other.

The electrolyte is a base selected from the group consisting of an alkaline earth metal hydroxide such as beryllium hydroxide (Be(OH)₂), magnesium hydroxide (Mg(OH)₂), strontium hydroxide (Sr(OH)₂), and calcium hydroxide (Ca(OH)₂) and an alkali metal hydroxide such as lithium hydroxide (LiOH), sodium hydroxide (NaOH), potassium hydroxide (KOH) and rubidium hydroxide (RbOH), and cesium hydroxide (CsOH). In a preferred embodiment, the electrolyte is KOH. The electrolyte is 0.1-3 M, more preferably 1-2.5 M, and yet more preferably 1.5-2.5 M, potassium hydroxide in an aqueous solution. The counter electrode is made from a material selected from the group consisting of platinum, gold, and carbon. The carbon may be in the form of graphite or glassy carbon.

The system has a specific activity of 2-4 milliampere per square centimeter (mA/cm²), more preferably 2.5-3.8 mA/cm² and yet more preferably 2.7-3.5 mA/cm². The system has an overpotential of 150 to 200 mV, preferably 175 to 185 mV, at 10 mA/cm². As used herein, the term ‘overpotential’ is referred to as the difference between the equilibrium potential for a given reaction (also called the thermodynamic potential) and the potential at which a catalyst operates at a specific current under specific conditions. The system has a turnover frequency of 2-6 s⁻¹, more preferably 2.5-5.5 s⁻¹, and yet more preferably 3-4 s⁻¹ at an overpotential of 0.32 V.

While not wishing to be bound to a single theory, such catalytic activity of the Fe₃O₄-ECs/FeF may be ascribed to the nanoscale morphology and porous structure of the catalyst that may weaken thermodynamic barriers for electron transfer and/or subsequent formation of O—O, the bond that consequently lower activation energy for OER, and ultimately enhances the OER performance of the catalyst. The uniform and continuous spherical morphology of the magnetite provides a high amount of catalytic active centers and thus improves the performance.

### EXAMPLES

The following examples describe and demonstrate exemplary embodiments of the electrocatalyst described herein. The examples are provided solely for the purpose of illustration and are not to be construed as limitations of the present disclosure, as many variations thereof are possible without departing from the spirit and scope of the present disclosure.

### Example 1: Materials and Methods

Fe(III) acetylacetonate (Fe(acac)₃, Fe(C₅H₂O₂)₃, 97%) and methanol anhydrous (99.8%) solvent were purchased from Sigma-Aldrich and were used without further purification or processing. The iron foam and nickel foam was obtained from commercial material companies, American Elements and Good Fellow respectively.

### Example 2: Fabrication of Magnetite Thin Film

Magnetite (Fe₃O₄) thin films were prepared using a custom-built aerosol-assisted chemical vapor deposition (AACVD). The Fe(acac)₃ precursor (100 milligrams (mg), 0.283 millimoles (mmols)) solution prepared in methanol (15 milliliters (mL)) was used in AACVD for the deposition of magnetite thin film. The deposition was observed on porous substrates such as nickel foam (NiF), iron foam (FeF), and stainless steel (SS) mesh of dimension (1×2 cm²) for a period of 80 minutes and at a fixed deposition temperature (480 degrees Celsius (C)) for every case.

A general AACVD experiment involves the transportation of precursor aerosol mist generated through an ultrasonic humidifier, towards a heated region of a tubular furnace connected with a reactor tube furnished with substrate strips. The precursor aerosol mist was driven with the help of carrier gas (industrial nitrogen (N₂) 99.9%)) at a flow rate of 100 cubic centimeters per minute (cm³/min). The temperature of the tubular furnace was set at 480° C. The deposition process was carried out for 80 minutes, and after that, the precursor gaseous stream was closed, and the furnace was switched off and cooled to room temperature (RT) under a constant flow of nitrogen. A similar process was prepared for every substrate, and as-synthesized samples were named as Fe₃O₄/FeF, Fe₃O₄/NiF, and Fe₃O₄/SS, respectively.

### Example 3: Electrochemical Investigations

Electrochemical tests were performed via a typical three-electrode configuration in 1.0 M KOH electrolyte solution having a pH of 14 on a computer-controlled potentiostat interface 1010E. Fe foam, Ni foam, and SS mesh (area=1×2 cm², exposed surface area=1×1 cm²) with deposited electrocatalyst over corresponding porous surfaces were directly employed as working electrodes. Spiral-shaped Pt wire was used as a counter electrode, and saturated silver/silver chloride (sat. Ag/AgCl) and mercury/mercury oxide (Hg/HgO in 1 M NaOH) electrodes were used as reference electrodes. Before each test, the glass cell was washed with 5% HCl solution and dried in an oven to avoid any impurities. Electrochemical measurements were performed in deoxygenated aqueous electrolyte solution at RT. All electrochemical data are presented with 10% IR correction. Polarization curves were recorded via linear sweep voltammetry at a scan rate of 2 millivolts per second (mV/s) otherwise mentioned.

Potentials were converted into reversible hydrogen electrodes (RHE) according to the Nernst equation (1).

$${E}_{RHE} = \cdot {E}_{REF} \cdot + \cdot {E}_{REF}^{0} + \cdot 0.059 \cdot ( pH ) \qquad ( 1 )$$

Overpotential is calculated according to equation (2).

$$Overpotential \cdot ( η ) \cdot = {E}_{RHE} \cdot - 1.23 \qquad ( 2 )$$

Tafel slopes are calculated from a linear region of the polarization curve where the Tafel region begins using the Tafel equation (3).

$$η = \cdot b \cdot log \cdot j + \cdot a \qquad ( 3 )$$

where b is the Tafel slope, and a is the constant.

Turn over frequency is calculated by equation (4).

$$TOF = \frac{j \times A}{4 \times n \times F} \qquad ( 4 )$$

where I is the current value achieved at a specific potential value observed from the linear polarization curve, A is the geometrical area of a working electrode that is 1 cm², n is the number of moles of a catalyst deposited over a substrate, 4 is the number of electrons transferred during the reaction and F is faradaic constant (96485.3 coulombs per mole (C/mol)).

Theoretically, mass activity is calculated by using equation (5).

Mass activity (mA/mg)·=I/mass·loading·of·catalyst (5) where I is the current obtained from the polarization curve at a specific potential value (here, mass activity of all catalytic systems have been calculated at 1.55 V vs. RHE), and m is the mass of catalysts deposited over a substrate.

Equation (5) may also be written as follows:

$$MA = \frac{J}{Active mass of catalyst} \qquad ( 5 )$$

Here J is the current density in mA cm⁻² at a specific overpotential value of 1.55 V vs. RHE for comparing the electrocatalytic activities of all systems discussed in the present disclosure.

Electrochemically active surface area (ECSA) for each catalytic system was obtained by measuring double layer charging capacitance of the electrocatalytic surface determined from the non-faradaic region of cyclic voltammetry (CV) at multiple scan rates from 10 mV/s to 60 mV/s of CVs. Non-faradaic current may be attributed to double-layer charging capacitance (C_{d1}) that yields a straight-line equation where slope presents double-layer charging capacitance according to equation (6).

$${i}_{c} = {vC}_{dl} \qquad ( 6 )$$

where i_{c} is the double-layer charging current, υ and C_{d1} are the scan rate and double-layer charging capacitance, respectively. ECSA was obtained by dividing double layer capacitance with a specific capacitance of a metal electrode as provided by equation (7).

$$ECSA = \cdot {C}_{dl} / {C}_{s} \qquad ( 7 )$$

here, Cₛ for different metal electrodes in alkaline electrolyte solutions such as NaOH and KOH lies in the range of 0.022 to 1.30 millifarad per square centimeter (mF/cm²) as mentioned in the literature. Here, 0.04 is chosen as a desired value of specific capacitance for measuring ECSA of Fe₃O₄ based electrodes working under alkaline conditions.

Specific activity is calculated by equation (8).

$$Specific activity ( {i}_{s} ) \cdot = \frac{I}{ECSA} \qquad ( 8 )$$

where I is the current obtained from a polarization curve at a specific potential (1.55 V) and ECSA is the ECSA of the electrode.

Exchange current density (J_{exc}) is calculated considering charge transfer resistance at electrode-electrolyte interphase using equation (9).

$$Jexc = \frac{RT}{nAF θ} \qquad ( 9 )$$

where R is a universal gas constant 8.314 joule per kelvin per mole (kg·m²·s⁻²)/K·mol, T is temperature 298 K, n represents a number of electrons which is 4 for OER, F is faraday constant 96485 C (A·s)/mol, θ is charge transfer resistance Ω (ohm) (kg·m²·s⁻³·A⁻²), A is the geometrical area of working electrodes that is 1 cm².

Fe₃O₄-ECs/FeF=8.314 J/K·mol×298 K/4×96485 C/mol×1.3Ω(2×1 cm²=4.9 mA/cm²

Fe₃O₄-ECs/SS=8.314 J/K·mol×298 K/4×96485 C/mol×1.9Ω×1 cm²=4.0 mA/cm²

Fe₃O₄-ECs/NiF==8.314 J/K·mol×298 K/4×96485 C/mol×6Ω×1 cm²=1.06 mA/cm²

Electrochemical impedance spectroscopy (EIS) was acquired to know charge transfer resistance (R_{ct}) and solution resistance (Rₛ) in a frequency range of 0.1 hertz (Hz) to 1 (megahertz) MHz at 1.6 V vs. RHE otherwise mentioned. Stability is evaluated via long-term controlled current electrolysis experiments at 10 and 20 mA/cm².

### Example 4: Morphological Investigations

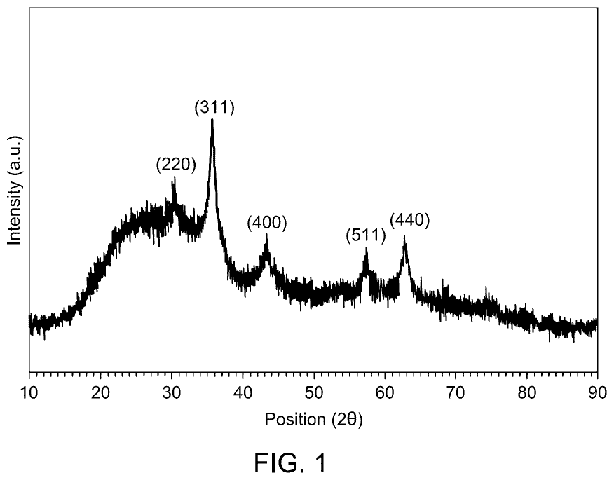

Morphological attributes of magnetite (Fe₃O₄) electrocatalysts deposited over various conducting substrates were examined thoroughly via various analytical techniques. X-Ray Diffraction (XRD) analysis was conducted to know about the phase of the deposited catalyst. The metallic substrates (FeF, NiF, SS) exhibit high crystallinity which suppresses the XRD pattern of the deposited sample and creates interference in characterizing the true phase and crystallinity of the deposited material. Therefore, thin films on non-crystalline plain glass under similar AACVD conditions were made and characterized by XRD. FIG. 1 indicates XRD pattern of iron oxide thin film deposited on a plain glass substrate. The crystalline peaks raised at 2θ position of 30.5°, 35.8°, 43.5°, 57.7° and 63.2° belongs to the hkl planes (220), (311), (400), (511) and (440), respectively (shown in FIG. 1).

XRD data indicates the formation of magnetite (Fe₃O₄) in the cubic phase as suggested by the standard matching pattern PDF 01-073-9877 known in the art. XRD data completely matches with magnetite Fe₃O₄, and no unmatched peak is found in XRD to indicate the formation of any other crystalline phase of iron oxide. Thus, the XRD result suggests the formation of phase pure Fe₃O₄.

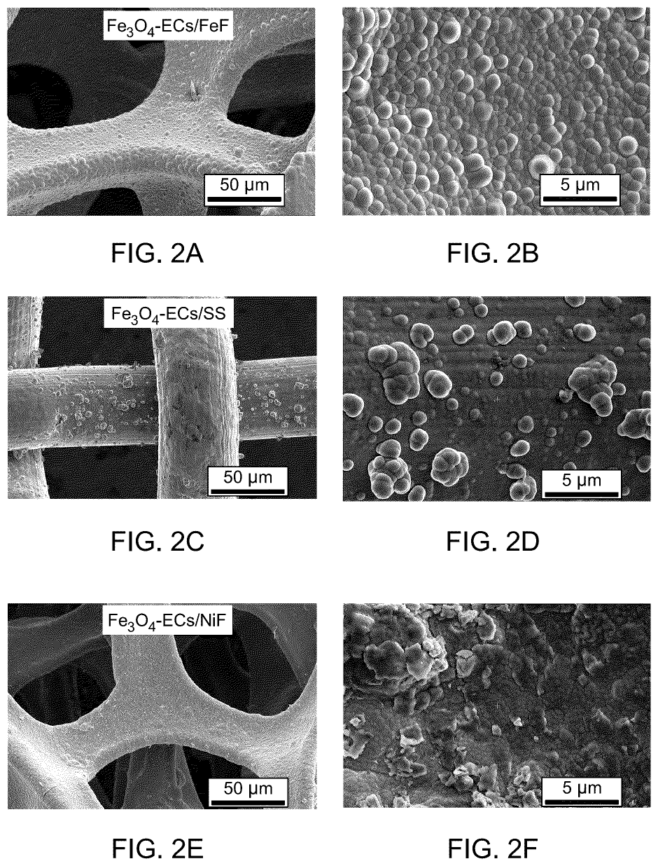

The morphology of developed catalytic films is examined by scanning electron microscopy (SEM); the results are indicated in FIGS. 2A-2F. High magnification images (FIGS. 2A, 2C, and 2E) further unveil the shape and texture of the fabricated material. Low magnification images (FIGS. 2B, 2D, and 2F) reveal efficient coverage of substrate surfaces with deposited material at 80 minutes of AACVD processing. On porous iron foam, Fe₃O₄ is developed in the form of nanospheres which are arranged in regular, compact, and dense fashion (FIG. 2B). When the substrate surface is replaced with a SS mesh, a heap of the spherical agglomerate is precipitated from the underneath Fe₃O₄ film (FIG. 2D). The film microstructural pattern has completely changed when NF act as substrate surface and flake like morphology without definite shape can be observed in FIG. 2F.

Developing films of varying morphology and microstructures is a trademark of AACVD by varying any corresponding deposition parameters like temperature, nature of substrate, deposition time and temperature, resulting in generation of material with variety of nanostructures which ultimately influences the OER catalytic activity. Such deposition variables transform the precursor decomposition pathways that result in a change of morphology and design of the thin film pattern.

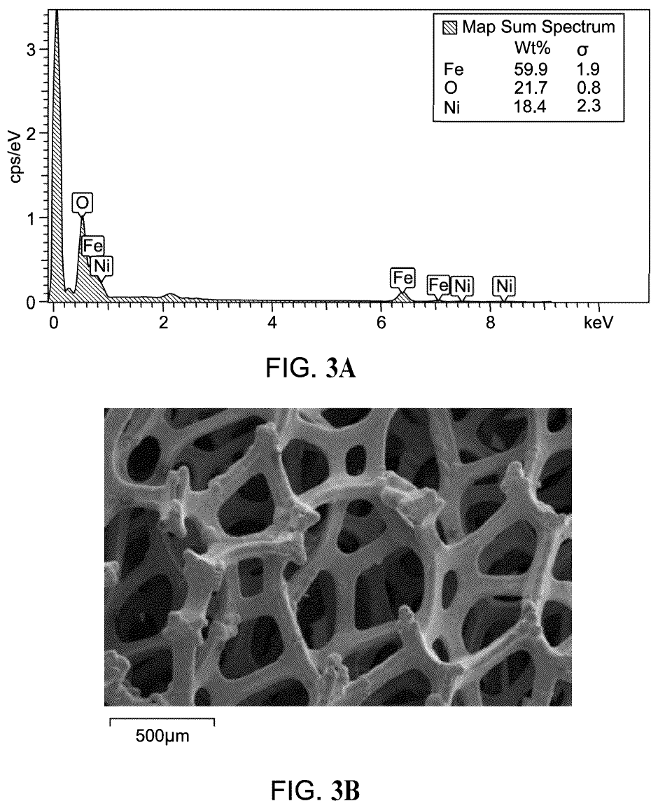

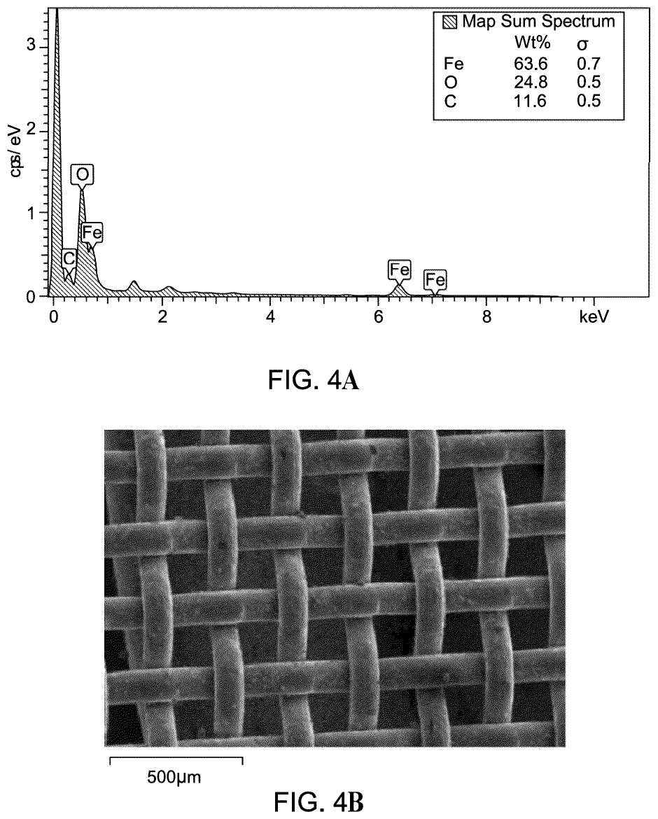

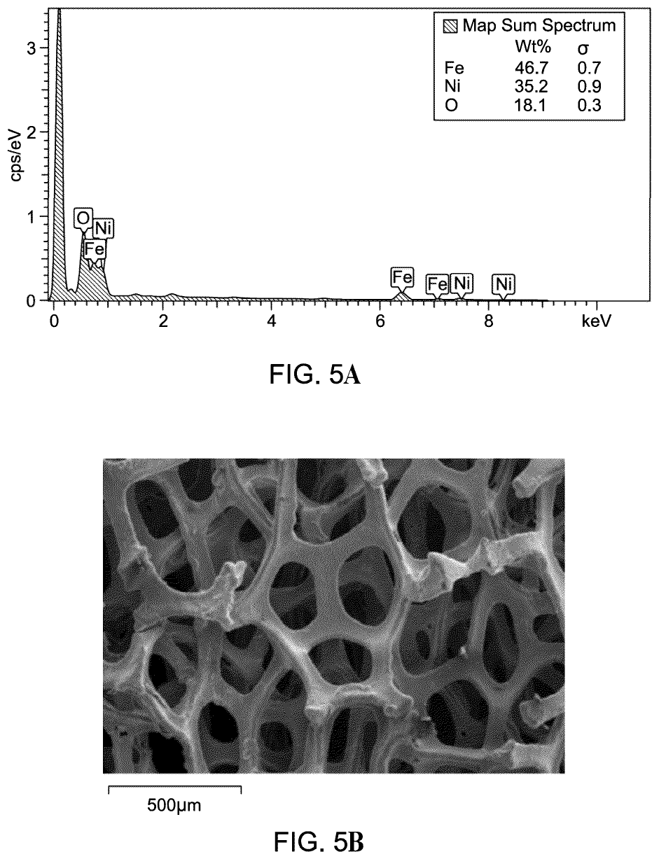

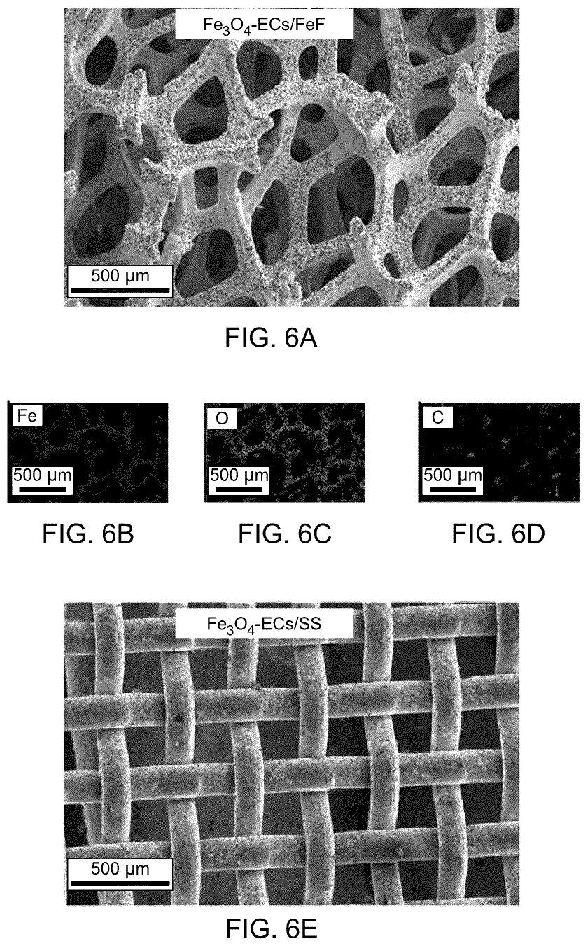

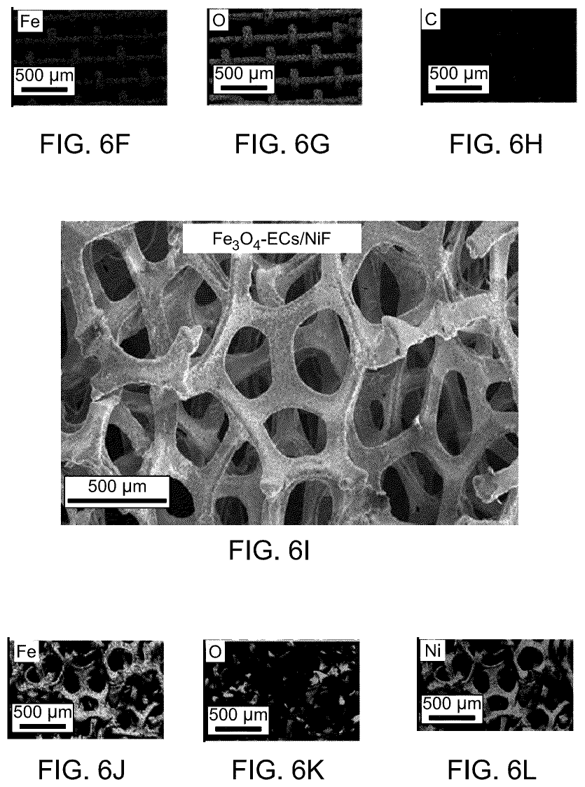

Elemental composition of catalysts energy dispersive X-ray spectroscopy (EDX) was undertaken. Elemental constituent's analysis suggests the presence of Fe and O as dominating metals in all catalytic samples (FIGS. 3-5). In the Fe₃O₄-ECs/NIF, Ni is also indicated that is associated with the underlying Ni substrate. The EDX spectrum reveals the weight percentage of Fe, and O to be 59.9% and 21.7 in the Fe₃O₄-ECs/FeF, 63.6%, and 24.7% in the Fe₃O₄-ECs/SS, and 46.7%, and 18.1% in the Fe₃O₄-ECs/NiF. Here, the weight percentage of Ni is found to be 35.3 due to underlying the NiF substrate. EDX elemental map shows the uniform distribution of Fe and O atoms on the surface of catalytic samples (FIGS. 6A-6L).

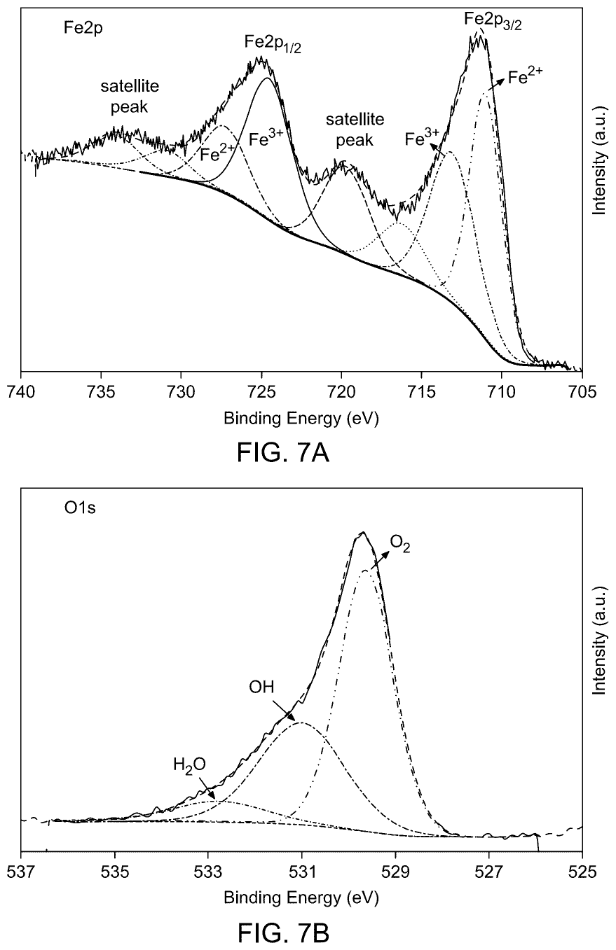

XPS analysis was conducted to understand the valence states of Fe and O atoms in magnetite thin film and FIGS. 7A-7B indicates high-resolution XPS spectra of such elements. The Fe 2p spectrum is deconvoluted into multiple peaks as shown in FIG. 7A. The spectral bands located at 713.2 electron volts (eV) and 727.4 eV are assigned to the 2p_{3/2} and 2p_{1/2} of Fe₃₊ species, respectively. The binding energy peaks found at 711 eV and 724.6 eV correspond to 2p_{3/2} and 2p_{1/2} of Fe²⁺ ions. The weak satellite peaks that emerged at 720 and 734 eV suggest the formation of pure magnetite (Fe₃O₄) phase thin films. The O1s spectrum (FIG. 7B) is split into three peaks appeared at binding energy of ˜530 eV, 531 eV and 533 eV, respectively, which were assigned to oxygen atoms in Fe₃O₄, hydroxide (OH) in the surface of metal oxide and specifically physically adsorbed H₂O, respectively.

### Example 5: Electrochemical Characterization

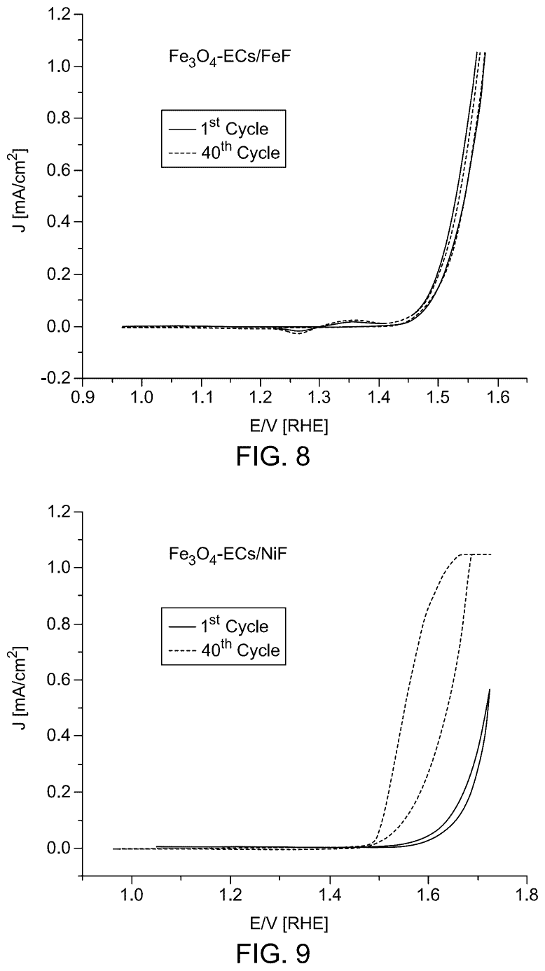

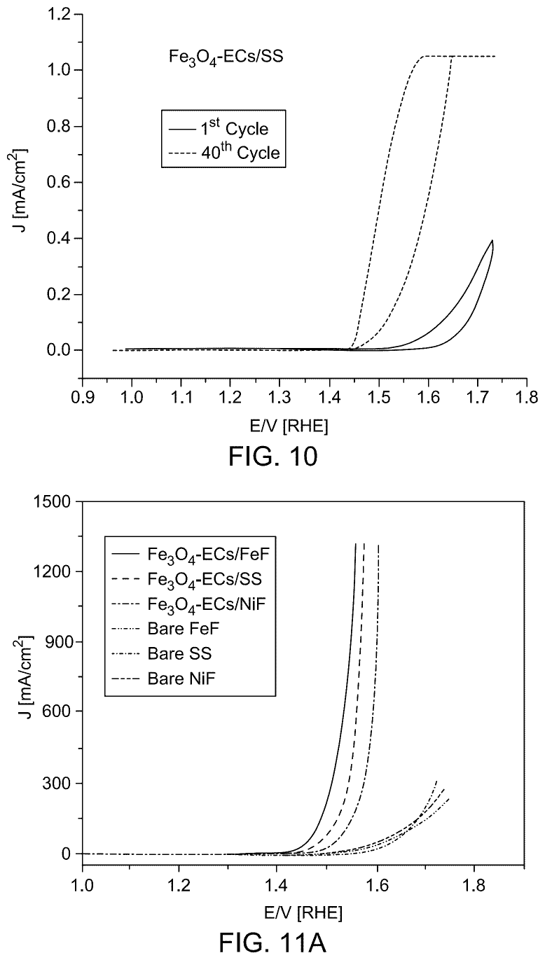

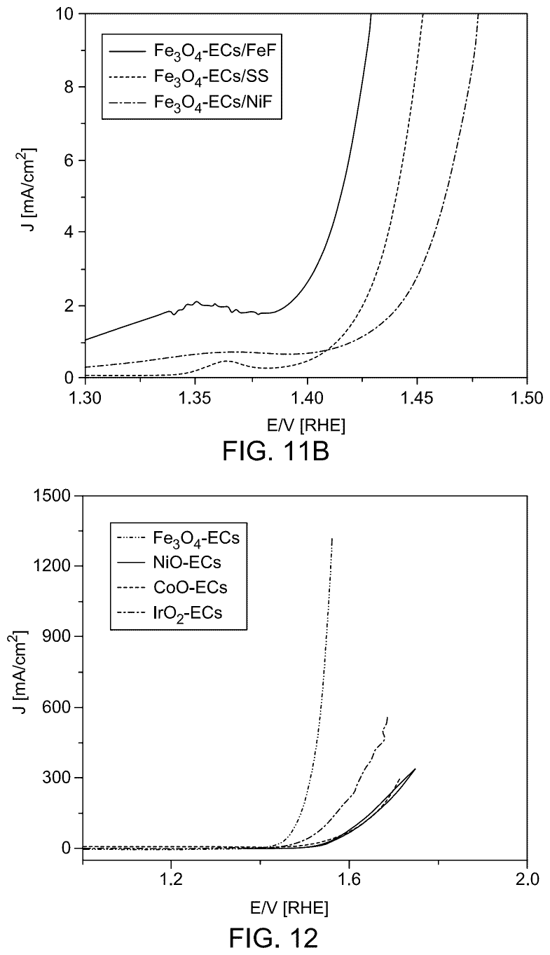

The Fe₃O₄ deposited over various porous and conductive substrates such as Fe foam, Ni foam and stainless-steel mesh was directly employed as electrodes for water oxidation reaction in a 1.0 M aqueous KOH electrolyte solution. Before recording OER characteristics, catalysts were activated by performing a concurrent CV experiment, and the results of this study are presented in FIGS. 8-10. After the 40th CV cycle, the Fe₃O₄-ECs/FeF does not show any distinct improvement in performance whereas the 1^{st} CV cycle exactly overlaps the 40th CV cycle. This shows that catalyst can be directly employed for OER activity without the need of any pre-activation process which is beneficial from an economical aspect. However, the other two catalysts show improvements in OER performance after the activation process, as presented in FIGS. 9-10. Following the pre-activation process, the catalysts were evaluated for OER activity. Linear sweep voltammetry (LSV) profile shows that all Fe₃O₄-based electrocatalysts derived water oxidation reactions at remarkably low over potential and achieve high current densities under a small potential window, as illustrated in FIG. 11A.

As per the literature, water oxidation catalytic assembly executing oxygen evolution below 1.55 V vs. RHE is regarded as an excellent OER electrocatalyst (Ehsan, M. A.; Khan, A.; Zafar, M. N.; Akber, U. A.; Hakeem, A. S.; Nazar, M. F., Aerosol-assisted chemical vapor deposition of nickel sulfide nanowires for electrochemical water oxidation. International Journal of Hydrogen Energy 2021, incorporated herein by reference in its entirety). All the catalytic systems described herein, Fe₃O₄-ECs/FeF, Fe₃O₄-ECs/SS, and Fe₃O₄-ECs/NiF, initiated water oxidation at much lower overpotentials such as 1.39 V vs. RHE, 1.43 V vs. RHE and 1.45 V vs. RHE. and achieved current decade at an overpotential of 0.18 V, 0.22 V and 0.24 V respectively.

Operational potential at 10 mA/cm² is another index to evaluate OER performance. Furthermore, the Fe₃O₄-ECs/FeF showed the best catalytic performance, whose onset potential starts earlier than the other two systems investigated under identical circumstances (FIG. 11B). It is observed that for the Fe₃O₄-ECs/FeF current density increased rapidly within narrow regime of potential is clear evidence of fast kinetics of OER. Such behavior during water oxidation supports a fast transfer of electrons at substrate-electrocatalyst interphase. The results are comparable and even better than the benchmark and competent catalysts such as RuO₂, IrO₂, and metallic Pd film reported previously. Considering practical applications, the OER performance of commercially available IrO₂ catalyst is also evaluated under similar electrochemical circumstances. A peak current density of above 1200 mA/cm² is observed for the Fe₃O₄-ECs/FeF (1.56 V vs. RHE) which is much larger than that of IrO₂ (peak current density of 600 mA/cm² achieved at 1.66 V vs. RHE). Catalytic activity is also compared with commercially available NiO and CoO catalysts (FIG. 12).

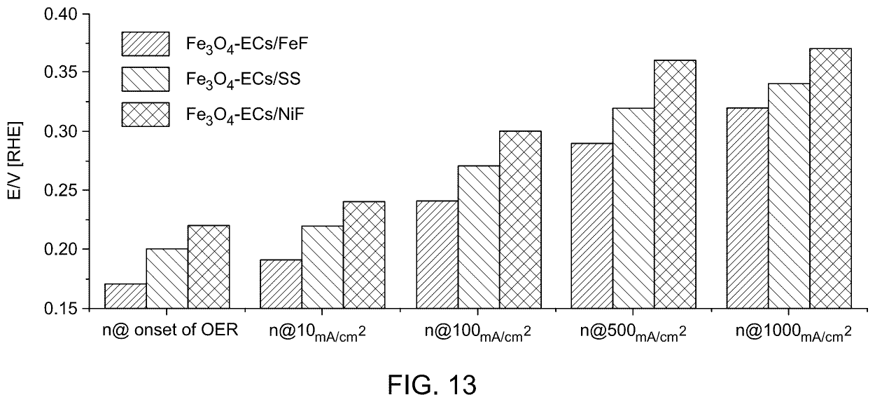

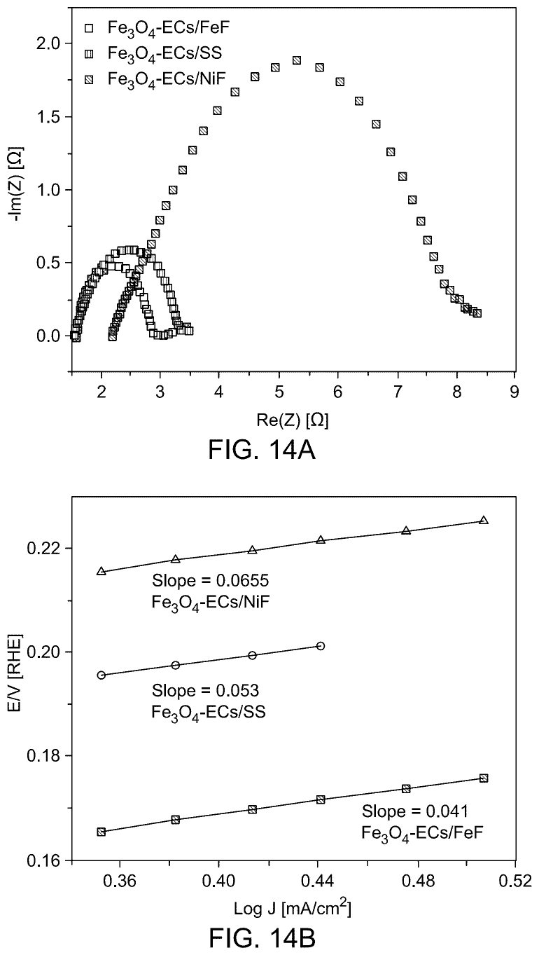

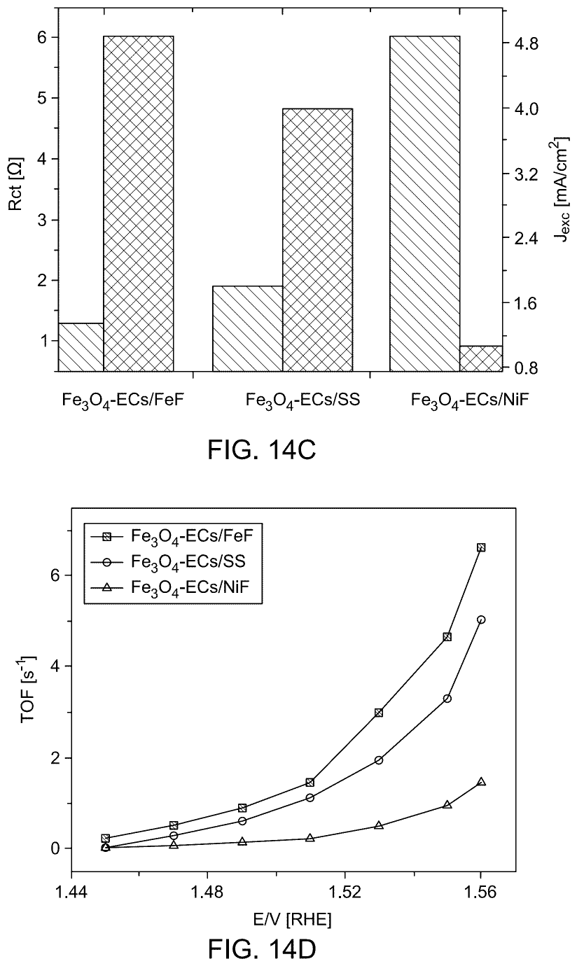

Such catalytic activity of the Fe₃O₄-ECs/FeF may be ascribed to the nanoscale morphology and porous structure of the catalyst that may weaken thermodynamic barriers for electron transfer and/or subsequent formation of O—O the bond that consequently lower activation energy for OER and ultimately enhances the OER performance of the catalyst. Furthermore, to reach the current density of 100 mA/cm² and 1000 mA/cm² the overpotential of 0.27 mV, 0.3 mV, and 0.34 mV, 0.37 mV is required for the Fe₃O₄-ECs/SS and, the Fe₃O₄-ECs/NiF, respectively. Whereas a dramatically lower overpotential of 0.24 m V and 0.32 m V is required for the Fe₃O₄-ECs/FeF (FIG. 13). This may be due to unique collaboration between the catalyst and underlying Fe foam-based conductive support that may have further enhanced catalytic performance. Consistently, this speculation was further confirmed by electrochemical impedance spectroscopy (EIS) measurement. Charge transfer resistance (R_{ct}) of the Fe₃O₄-ECs/FeF (1.3Ω) is smaller than that of the Fe₃O₄-ECs/SS (1.9Ω), and Fe₃O₄-ECs/NiF (6.0 g) (FIG. 14A).

Tafel slope is an indicator to access the intrinsic catalytic kinetics of OER which can be obtained from overpotential and corresponding current density. The Fe₃O₄-ECs/FeF showed a low Tafel slope of 0.041 volts per decade (V/dec) reflecting superior OER kinetics. For the Fe₃O₄-ECs/SS and, Fe₃O₄-ECs/NiF Tafel slope is approximately 0.053 mV/dec and 0.065 mV/dec. A Tafel slope of 0.041 mV/dec indicates the third step (M-OOH) as rate-determining step, which means that as prepared electrode facilitates the energy-intensive step during the water oxidation process (FIG. 14B). Smaller value also shows less resistive nature of the catalyst that is highly desirable to address the inactive kinetics of water oxidation process. Specifically, the Tafel slope of the Fe₃O₄-ECs/FeF (0.041 mV/dec) is smaller than that of the RuO₂ nanoscale catalyst (0.059 mV/dec) revealing that the former is a promising catalyst for OER. To examine the intrinsic activity of catalysts, exchange current density was calculated from the charge transfer resistance value. The Fe₃O₄-ECs/FeF, Fe₃O₄-ECs/SS, and Fe₃O₄-ECs/NiF show exchange current density values of 4.9 mA/cm², 4 mA/cm² and 1.06 mA/cm² respectively (FIG. 14C).

Fe atoms deposited over conductive substrate were assumed to be catalytically active, and turnover frequency (TOF) was calculated using equation (4) and is shown in table 1.

TOF@ 1.45V=[(0.043 A)×(1 cm²)]/[(4)×(5.18285×10⁻⁷ mol)×(96485 C mol¹⁻)]=0.21 s⁻¹

TOF@ 1.47V=[(0.105)×(1 cm²)]/[(4)×(5.18285×10⁻⁷ mol)×(96485 C mol¹⁻)]=0.52 s⁻¹

TOF@ 1.49V=[(0.175)×(1 cm²)]/[(4)×(5.18285×10⁻⁷ mol)×(96485 C mol¹⁻)]=0.87 s⁻¹

TOF@ 1.51V=[(0.29)×(1 cm²)]/[(4)×(5.18285×10⁻⁷ mol)×(96485 C mol¹⁻)]=1.44 s⁻¹

TOF@ 1.53V=[(0.597)×(1 cm²)]/[(4)×(5.18285×10⁻⁷ mol)×(96485 C mol¹⁻)]=2.9 s⁻¹

TOF@ 1.55V=[(0.932)×(1 cm²)]/[(4)×(5.18285×10⁻⁷ mol)×(96485 C mol¹⁻)]=4.6 s⁻¹

TOF@ 1.56V=[(1.321)×(1 cm²)]/[(4)×(5.18285×10⁻⁷ mol)×(96485 C mol¹⁻)]=6.6 s⁻¹

TABLE 1
Turn over frequency calculations from OER polarization
curves at various applied potentials for all catalysts.

| | Fe₃O₄- | Fe₃O₄- | Fe₃O₄- |
|---|---|---|---|
| TOF (s⁻¹) | ECs/FeF | ECs/SS | ECs/NiF |
| TOF@1.45 | 0.2 | 0.02 | 0.03 |
| TOF@1.47 | 0.5 | 0.27 | 0.05 |
| TOF@1.49 | 0.8 | 0.61 | 0.13 |
| TOF@1.51 | 1.4 | 1.12 | 0.2 |
| TOF@1.53 | 2.9 | 1.94 | 0.5 |
| TOF@1.55 | 4.6 | 3.29 | 0.94 |
| TOF@1.56 | 6.6 | 5.03 | 1.45 |

Table 1 shows that the Fe₃O₄-ECs/FeF showed TOF of 4.6 s⁻¹ at 1.55 V vs RHE relative to the Fe₃O₄-ECs/SS and, Fe₃O₄-ECs/NiF which show TOF values of 3.2 s⁻¹ and 0.9 s⁻¹ (FIG. 14D).

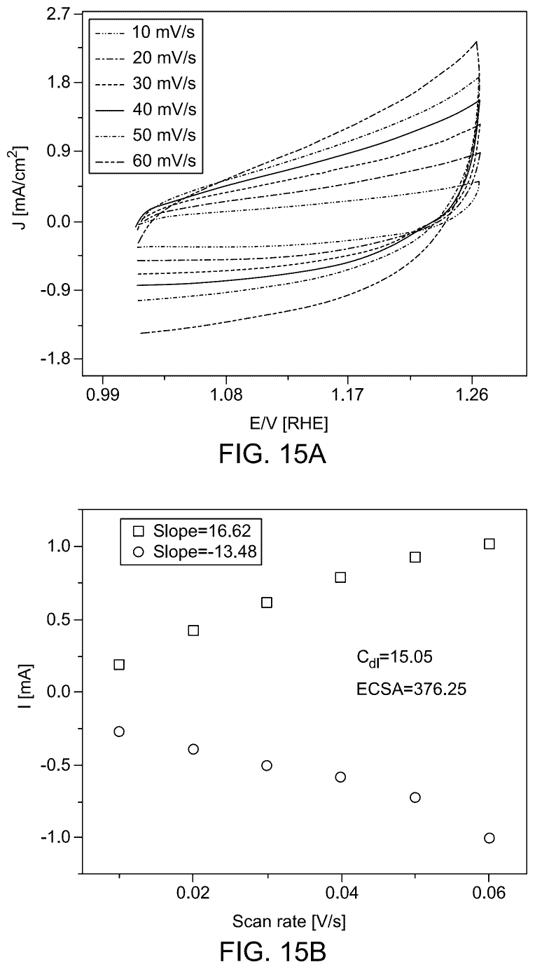

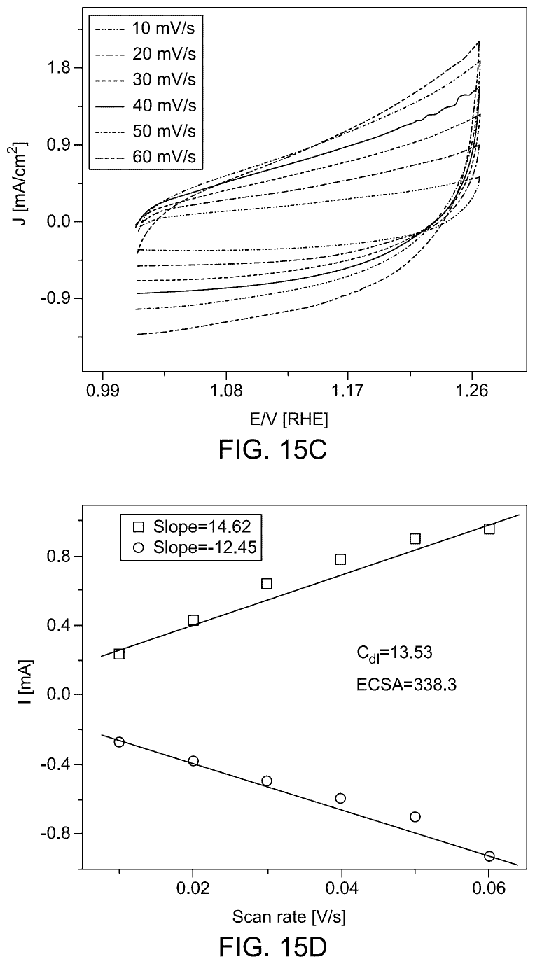

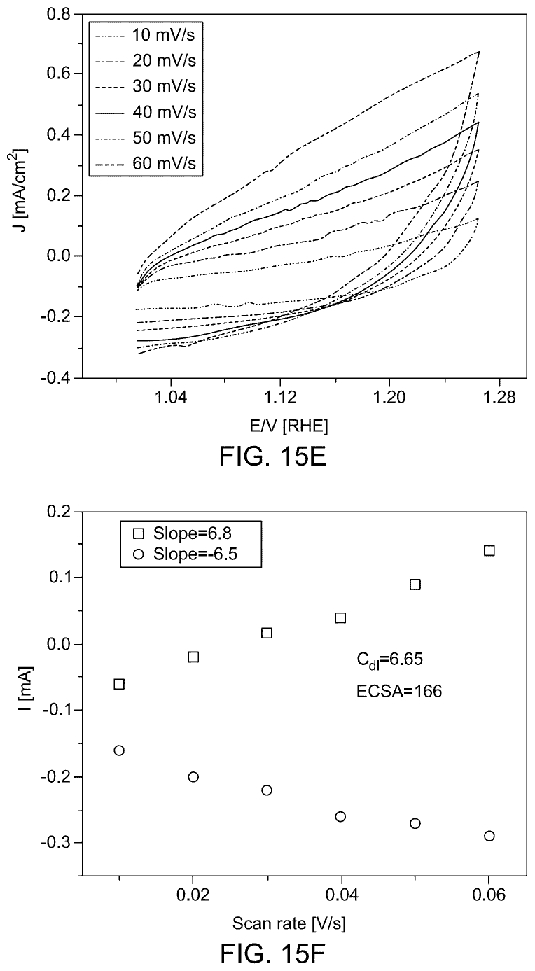

The electrochemical performance of catalysts often depends on the corresponding active surface area. ECSA of the Fe₃O₄-ECs/FeF, Fe₃O₄-ECs/SS, Fe₃O₄-ECs/NiF electrocatalysts in 1.0 aq. KOH electrolyte solution were measured by double-layer capacitance measurements to examine the enhanced OER activity and are presented in FIGS. 15A-15F. In FIG. 15B, FIG. 15D and FIG. 15F, slopes give values of double layer capacitance and averaging absolute values of slopes of linear fits to the data, the ECSA found to be 376.25, 338.3, 166 square centimeters (cm²) (geometrical area of the working electrode is 1 cm²).

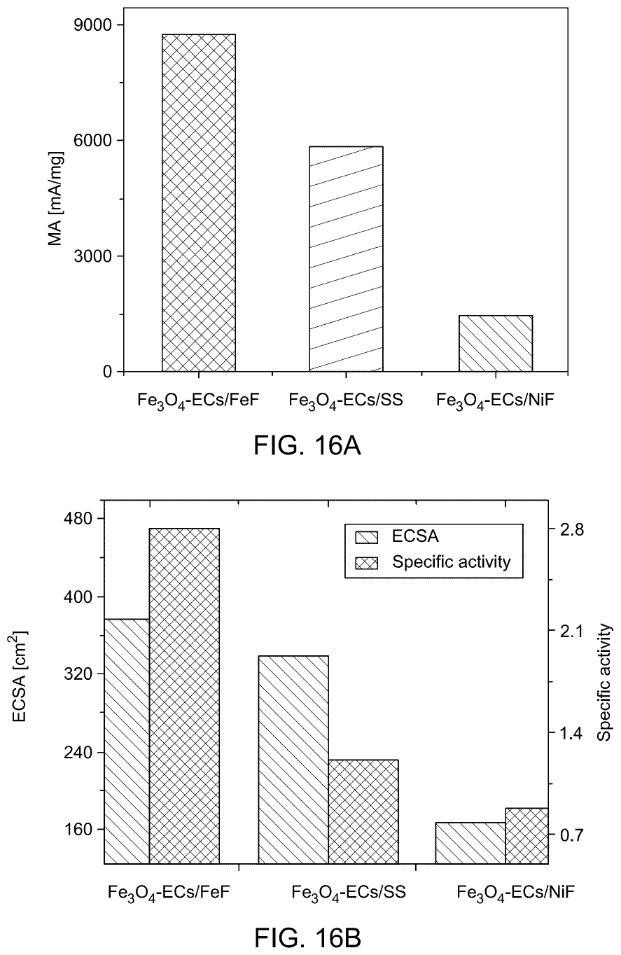

The steeply high capacitance of 15.05 for the Fe₃O₄-ECs/FeF indicates high ECSA of 376 cm² comparable to other systems such as the Fe₃O₄-ECs/SS, and the Fe₃O₄-ECs/NiF, which show ECSA of 338.3 cm² and 166 cm², respectively. Furthermore, the Fe₃O₄-ECs/FeF shows high mass activity and specific activity of 8750 mA/mg and 2.79 mA/cm², respectively (mass activity and specific activity of other systems are shown below) (FIGS. 16A-16B, Table 2).

Fe₃O₄-ECs/FeF=1050 mA/0.12 mg=8750 mA/mg

Fe₃O₄-ECs/SS=410 mA/0.07 mg=5857 mA/mg

Fe₃O₄-ECs/NiF=146 mA/0.1 mg=1460 mA/mg

Fe₃O₄-ECs/FeF=1050 mA/376.25 cm²=2.79 mA/cm²

Fe₃O₄-ECs/SS=338.3 mA/338.3 cm²=1.21 mA/cm²

Fe₃O₄-ECs/NiF=146 mA/166 cm²=0.87 mA/cm²

TABLE 2
Comparative evaluation of electrochemical parameters for all electrocatalysts

| | | | Mass | Specific | | Exchange | |
|---|---|---|---|---|---|---|---|
| | Tafel | | activity | activity | | current | TOF |
| | Slope | R_{CT} | (mA/mg) | (mA/cm²) | ECSA | density | (s⁻¹) |
| Catalyst | (mV/dec) | (Ω) | @1.55 V | @1.55 V | (cm²) | (mA/cm²) | @1.55 V |
| Fe₃O₄- | 41 | 1.3 | 8750 | 2.79 | 376.25 | 4.9 | 4.6 |
| ECs/FeF | | | | | | | |
| Fe₃O₄- | 53 | 1.9 | 5857 | 1.21 | 338.3 | 4 | 3.2 |
| ECs/SS | | | | | | | |
| Fe₃O₄- | 65 | 6 | 1460 | 0.87 | 166 | 1.06 | 0.9 |
| ECs/NiF | | | | | | | |

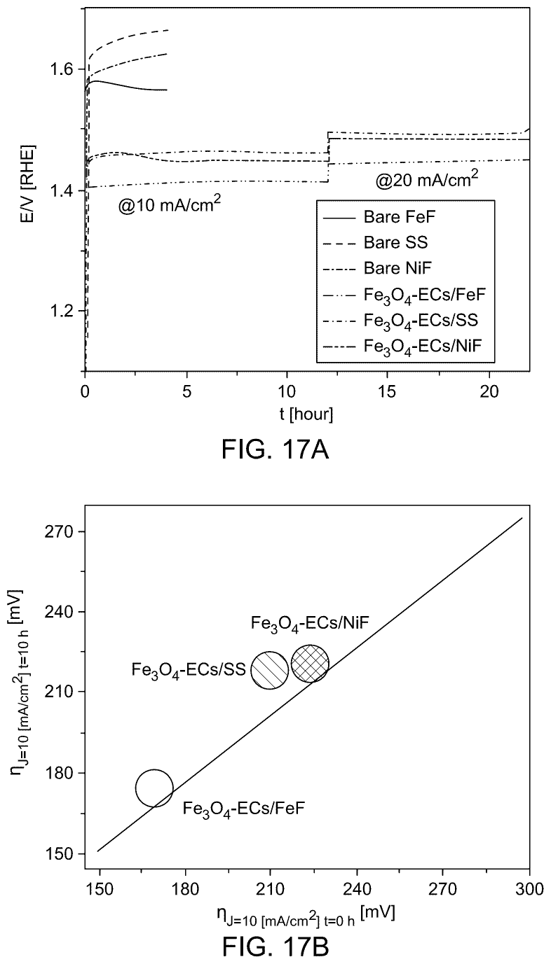

Durability is a factor in investigating the applicability of any catalytic system. Herein, the stability of catalytic systems was investigated by controlled current electrolysis (CCE) experiments in 1.0 M aqueous KOH electrolyte solution. FIG. 17A illustrates that the Fe₃O₄-ECs/SS and, Fe₃O₄-ECs/NiF produced stable current densities of 10 mA/cm² at 1.44 (η=0.21 V) V vs. RHE and 1.46 V vs. RHE (η=0.23 V) and 20 mA/cm² at stable potential values of 1.48 V vs. RHE (η=0.25 V) and 1.50 V vs. RHE (η=0.27 V). However, the Fe₃O₄-ECs/FeF presents the best catalytic performance as compared to other systems and maintains 10 mA/cm² and 20 mA/cm² at lower potentials of 1.40 V vs. RHE (η=0.17 V) and 1.44 V vs. RHE (η=0.21 V) under similar electrochemical conditions.

The catalytic stability was evaluated at 10 mA/cm² for 10 hours, and overpotential was studied as a function of time. FIG. 17B shows overpotential at t=0 hours plotted against overpotential at t=10 hours for all three catalytic systems. In FIG. 17B, the x-axis is the overpotential required to achieve the current density of 10 mA cm⁻² per geometrical area of the electrode at t=0, and the y-axis is the overpotential needed to accomplish the current density of 10 mA cm⁻² per geometrical area of the electrode at t=10 h during CCE. The diagonal line is the expected response of the catalyst that does not alter during continuous 10 h. The catalyst below the diagonal line is regarded as electroactive, that on the line is viewed as stable, and that above the line has shown some degradation.

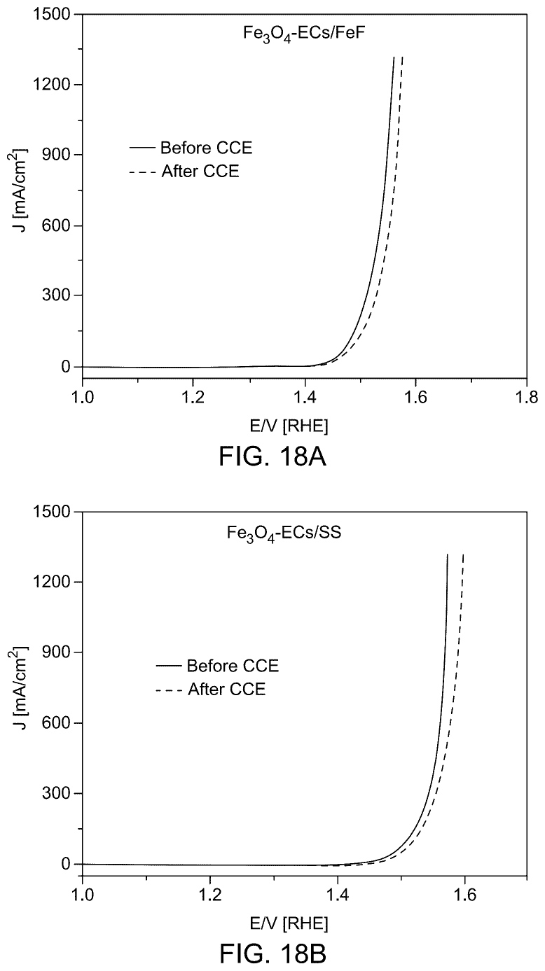

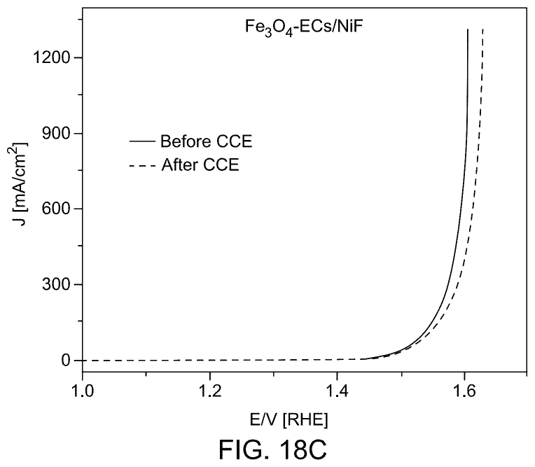

Any materials whose overpotential value to achieve a current decade lies after 500 mV, 400-500 mV, 300-400 mV, and 200-300 mV in x-axis and y-axis are regarded as only satisfactory, good, and ideal respectively for water oxidation catalysis (FIG. 17B). Results reveal that all catalytic systems discussed in the current disclosure were shown to produce stable current decade at the lower potential range of 170 mV to 230 mV. Therefore, all the materials can be considered catalysts and show substantial catalytic performance for water oxidation. The Fe₃O₄-ECs/FeF is the highest performing as it is shown to maintain the current decade at just 170 mV. This may be due to relatively high ECSA and lower charge transfer resistance that facilitate electronic transfer at a lower energy cost. FIGS. 18A-18C represent forward potential sweeps for OER recorded at a scan rate of 5 mV s⁻¹ Fe₃O₄-ECs/FeF, Fe₃O₄-ECs/SS, Fe₃O₄-ECs/NiF before and after long-term stability test in 1.0 M aq. KOH electrolyte solution, indicating high stability in the electrolyte.

Numerous modifications and variations of the present disclosure are possible in light of the above teachings. It is therefore to be understood that within the scope of the appended claims, the invention may be practiced otherwise than as specifically described herein.

1: An electrocatalyst, comprising:
an iron foam substrate; and
magnetite (Fe₃O₄),
wherein at least one layer of the Fe₃O₄ is deposited onto the iron foam substrate,
wherein the at least one layer of the Fe₃O₄ on the iron foam substrate is continuous,
wherein the at least one layer of the Fe₃O₄ on the iron foam substrate has a thickness of 0.01 micrometer (μm) to 50 μm, and
wherein the Fe₃O₄ is in a form of particles having a spherical shape with an average diameter of 0.01 to 2 μm.

2: The electrocatalyst of claim 1, wherein the Fe₃O₄ is uniformly distributed on the iron foam substrate.

3: The electrocatalyst of claim 1, wherein particles of the Fe₃O₄ are not aggregated.

4: The electrocatalyst of claim 1, wherein particles of the Fe₃O₄ form a monolayer on the iron foam substrate.

5: The electrocatalyst of claim 1, wherein at least 90% of an outer surface area of the iron foam substrate is covered with particles of the Fe₃O₄.

6: The electrocatalyst of claim 1, wherein the average diameter of the particles of Fe₃O₄ is 0.1 to 1 μm.

7: The electrocatalyst of claim 1, wherein the Fe₃O₄ has a cubic phase.

8: The electrocatalyst of claim 1, having Fe²⁺ and Fe³⁺ species.

9: The electrocatalyst of claim 1, wherein a distribution of the average diameter of the particles of Fe₃O₄ does not vary by more than 100 nanometers (nm).

10: The electrocatalyst of claim 1, wherein the iron foam substrate is porous and has an average pore size of 50 to 500 μm.

11: The electrocatalyst of claim 10, wherein the pores have a spherical shape.

12: The electrocatalyst of claim 1, having 60-80 wt. % iron and 20-40 wt. % oxygen, based on a total weight of the electrocatalyst.

13: An oxygen evolution catalytic system, comprising:
the electrocatalyst of claim 1;
a counter electrode; and
an electrolyte,
wherein the electrocatalyst and the counter electrode are at least partially submerged in an aqueous solution of the electrolyte and are not in physical contact with each other.

14: The oxygen evolution catalytic system of claim 13, wherein the electrolyte is a base selected from the group consisting of an alkaline earth metal hydroxide and an alkali metal hydroxide.

15: The oxygen evolution catalytic system of claim 13, wherein the electrolyte is 0.1-3 molar (M) potassium hydroxide in an aqueous solution.

16: The oxygen evolution catalytic system of claim 13, wherein the counter electrode is made from a material selected from the group consisting of platinum, gold, and carbon.

17: The oxygen evolution catalytic system of claim 13, having a specific activity of milliampere per square centimeter (2-4 mA/cm²).

18: The oxygen evolution catalytic system of claim 13, having an overpotential of 150 to 200 millivolts (mV), at 10 mA/cm².

19: The oxygen evolution catalytic system of claim 13, having a turnover frequency of 2-6 second inverse (s⁻¹) at an overpotential of 0.32 V.
